(19) United States
(12) Patent Application Publication
(10) Pub. No.: US 2025/0097684 A1
(43) Pub. Date: Mar. 20, 2025

(54) HIGH-RELIABILITY AND HIGH-ROBUSTNESS ROUTING METHOD FOR MARITIME SEARCH AND RESCUE WIRELESS SENSOR NETWORKS

(71) Applicant: Shanghai Maritime University, Shanghai (CN)

(72) Inventors: Jiangfeng XIAN, Shanghai (CN); Junling MA, Shanghai (CN); Huafeng WU, Shanghai (CN); Xiaojun MEI, Shanghai (CN); Weijun WANG, Shanghai (CN); Yuanyuan ZHANG, Shanghai (CN); Xinqiang CHEN, Shanghai (CN); Yongsheng YANG, Shanghai (CN); Chaofeng LI, Shanghai (CN)

(21) Appl. No.: 18/971,586

(22) Filed: Dec. 6, 2024

Related U.S. Application Data
(63) Continuation of application No. PCT/CN2024/097920, filed on Jun. 7, 2024.

(30) Foreign Application Priority Data
Sep. 19, 2023 (CN) 202311207371.2

(51) Int. Cl. H04W 4/90; H04W 40/20; H04W 40/30

(52) U.S. Cl. CPC H04W 4/90; H04W 40/20; H04W 40/30

(57) ABSTRACT

A high-reliability and high-robustness routing method for MSR-WSNs is provided, including: S1: generating an initial dynamic topological structure of MSR-WSNs; S2: determining a cluster head node for any maritime search and rescue node, and joining a corresponding cluster to obtain a set of clusters; S3: calculating a predicted forward distance of a maritime search and rescue data packet of a target node; S4: calculating the correct reception rate among nodes under the communication link of the maritime search and rescue environment; S5: calculating and sorting the priority of each relay node from high to low according to the priority; S6: when carrying out the task of forwarding maritime search and rescue data packets, the target nodes select the candidate relay nodes in turn and combined with the reliable response mechanism to forward until the maritime search and rescue data packets are successfully received by search and rescue ship.

### CROSS-REFERENCE TO RELATED APPLICATIONS

This application is a continuation of PCT/CN2024/097920, filed on Jun. 7, 2024 and claims priority of Chinese Patent disclosure No. 202311207371.2, filed on Sep. 19, 2023, the entire contents of which are incorporated herein by reference.

### TECHNICAL FIELD

The disclosure relates to a technical field of marine wireless sensor network routing, and in particular to a high-reliability and high-robustness routing method for maritime search and rescue wireless sensor networks (MSR-WSNs).

### BACKGROUND

In recent years, wireless sensor networks have been widely used in marine ecological environment monitoring, maritime search and rescue and far-reaching ocean observation. In the process of maritime search and rescue, wireless sensor nodes are preset on life jackets in advance (nodes are activated automatically when encountering water), and a multi-hop network is formed through self-organization to complete the perception and transmission of search and rescue information. This system is superior in that: through the self-organizing network characteristic of the wireless sensor nodes, the active release of search and rescue information is realized, and search and rescue ships and shore-based search and rescue centers obtain the real-time geographical location information and vital signs information of people overboard, thus greatly improving the efficiency of maritime search and rescue.

However, the design of existing routing methods of maritime search and rescue wireless sensor networks (MSR-WSNs) faces the following challenges: firstly, the nodes deployed on the sea are limited in energy and the batteries are usually not rechargeable and replaceable, so the energy saving is the first consideration for the design of routing algorithm; besides, the offshore environment is complex and changeable, the nodes drift randomly under the action of wind waves and currents, and the network topology is highly dynamic; the real-time dynamic changes of node position and network topology structure have adverse effects on the communication among nodes; moreover, under the limitation of current search and rescue equipment and maritime communication conditions, the design of MSR-WSNs routing method should ensure the reliability and real-time performance of data transmission in the network. At the same time, the dynamic change of network topology and the joining and quitting of some nodes may also lead to the incompleteness and randomness of network coverage in time and space; in addition, MSR-WSNs still has some unique constraints in life cycle, perception accuracy and reliability. All the above characteristics directly or indirectly affects the energy consumption performance and robustness of the MSR-WSNs routing method, causing low efficiency and other problems.

Most of the existing research methods are based on terrestrial wireless sensor networks and underwater wireless sensor networks, which are deployed in a (relatively) static environment and fail to fully consider the mobility of nodes, especially in the case of time-varying network topology in maritime search and rescue environment and unstable wireless communication links affected by waves, and making it difficult to realize high-reliability and high-robustness transmission of MSR-WSNs sensing data.

### SUMMARY

In order to solve the problem of robust and efficient transmission of sensing data caused by frequent node movement, dynamic change of network topology and high delay in maritime search and rescue scenes, the disclosure provides a high-reliability and high-robustness routing method for maritime search and rescue wireless sensor networks (MSR-WSNs), the method is suitable for maritime search and rescue wireless sensor networks with time-varying topology and unstable communication links, and realizes a high-reliability and high-robustness transmission of MSR-WSNs sensing data, effectively improving the efficiency and success rate of maritime search and rescue, and reducing network energy consumption.

The objective of the disclosure is achieved by a following technical scheme.

A high-reliability and high-robustness routing method for MSR-WSNs includes following steps:
S1, generating an initial dynamic topological structure of MSR-WSNs, where the topological structure includes a plurality of maritime search and rescue nodes and target nodes, where the maritime search and rescue nodes are evenly distributed;
S2, generating a random number between 0 and 1 for each maritime search and rescue node and compares the random number with the threshold value, and determining whether the maritime search and rescue node is a cluster head node according to a comparison result, where the maritime search and rescue node being not a cluster head node selects a maritime search and rescue cluster corresponding to a cluster head node with a smallest indication value of a maritime search and rescue cluster, and joins the maritime search and rescue cluster to obtain a set of maritime search and rescue clusters;
S3, calculating predicted values of advance distances of maritime search and rescue data packets of the target nodes by using an adaptive filtering method;
S4, predicting a connectivity of communication links in maritime search and rescue environment and calculating a correct reception rate among nodes;
S5, according to the set in the S2, determining a relay node of any maritime search and rescue node in each cluster, calculating a priority of each relay node according to the predicted values of advance distances of the maritime search and rescue data packets in the S3, the correct reception rate among the nodes in the S4 and residual energy of the nodes, and ranking the priorities from high to low according to the priority value; and
S6, taking any maritime search and rescue node receiving the maritime search and rescue data packet of the target node as a current node, introducing a reliable response mechanism, selecting a relay node corresponding to the current node to forward the data packet according to the priority, taking the relay node selected as a current node, and repeating the selecting of relay node and current node to forward until the maritime search and rescue data packet is successfully received by a search and rescue ship.

Optionally, the indication value of the maritime search and rescue cluster is:

$${MSR}_{Instruction} ( {n}_{i} , {n}_{j} ) = {ω}_{1} \times NRS ( {n}_{i} , {n}_{j} ) + {ω}_{2} \times NGLS ( {n}_{i} , {n}_{j} )$$

where nᵢ and nⱼ represent i-th and j-th maritime search and rescue nodes respectively, ω₁ and ω₂ represent weight coefficients of a received signal strength value similarity and a geographical location information similarity respectively, NRS represents a regularized received signal strength value similarity, and NGLS represents a regularized geographical location information similarity.

Further, the predicted values of the advance distances of the maritime search and rescue data packets are:

$${\hat{d}}_{ij}^{t} = {ω}_{1}^{′} {\hat{d}}_{ij}^{t - 1} + {ω}_{2}^{′} {\hat{d}}_{ij}^{t - 2} + … + {ω}_{q}^{′} {\hat{d}}_{ij}^{t - q}$$

where at \hat{d}ᵢ_{ⱼ}^{t-1}, \hat{d}ᵢ_{ⱼ}^{t-2}, . . . , \hat{d}ᵢ_{ⱼ}^{t-q} represent predicted values of advance distances of q maritime search and rescue data packets towards the search and rescue ship when the maritime search and rescue data packets sent to the node i are forwarded by a neighbor node i; of the node i, \hat{d}ᵢ_{ⱼ}^{t}, represents a predicted value of the advance distance of the maritime search and rescue data packets at a timing t, where ω′ represents weight, and an update of ω′ is:

$${ω}_{i}^{′ t} = {ω}_{i}^{′ t - 1} + 2 υ {e}_{i} {{d}^{⌢}}_{{i}_{j}}^{t - i}$$

where v represents a learning constant, and e; represents a learning error of dir.

Further, the advance distance represents a difference between a Euclidean distance between node i and the search and rescue ship and a Euclidean distance between node i, and the search and rescue ship.

Further, the correct reception rate among the nodes is:

$$P ( {P}_{R} ( d ) \geq Th ) = ℘ = Q ( \frac{Th - {E}_{{P}_{R} ( d )}}{σ} )$$

where [symbol] represents a correct reception rate, P_{R}(d) represents a signal strength received by the nodes, d represents a distance between the node sending information and the node receiving information, Th represents an information strength threshold; if the signal strength received by nodes is greater than or equal to the information strength threshold, a correct reception among nodes is realized,
where

$$Q ( Z ) = \frac{1}{\sqrt{2 π}} {\int }_{Z}^{∞} exp ( \frac{- {χ}^{2}}{2} ) dx$$

the signal strength of the node i receiving information sent by a node with a distance d is:

$${[ {P}_{R} ( d ) ]}_{dBm} = {[ {P}_{T} ]}_{dBm} - {[ PL ( {d}_{0} ) ]}_{dBm} - 10 α {log}_{10} ( \frac{d}{{d}_{0}} ) - {[ {X}_{σ} ]}_{dBm}$$

where P_{T} represents transmitting power of the nodes, PL(d₀) represents a signal strength loss value when a reference distance d₀=1 m, α represents a path loss attenuation index, and X_{σ} represents a wave shielding factor obeying Gaussian distribution with an expected value of 0 and a variance of σ².

Further, when the correct reception is realized among the nodes, the transmitting power of the nodes satisfies:

$${P}_{T} \geq PL ( {d}_{0} ) + 10 α {log}_{10} ( \frac{d}{{d}_{0}} ) + Th + {X}_{σ}$$

where PL(d₀) represents the signal strength loss value when the reference distance d₀=1 m, α represents the path loss attenuation index, and X, represents the wave shielding factor obeying the Gaussian distribution with the expected value of 0 and the variance of σ².

Further, specific steps of determining the relay node of the node i are as follows:
for the node i, calculating an intersection unit of a node set in a cluster where the node i is located and a neighbor node set of the node i, and taking all nodes in the intersection set as relay nodes of the node i.

Further, the priority of the relay nodes of the node i is:

$${P}_{{i}_{j}} ( t ) = ln ( 1 + {{d}^{⌢}}_{{i}_{j}}^{t} \cdot \cdot {e}_{{i}_{j} - residual}^{t} )$$

where \hat{d}ᵢ_{ⱼ}^{t}, represents a predicted value of the advance distance of the maritime search and rescue data packet at a timing t, [symbol] represents the correct reception rate, and eᵢ_{ⱼ}_{-residual}^{t} represents the residual energy of the node at the timing t.

Further, specific steps of selecting the relay node corresponding to the current node for data packet forwarding according to the priority are as follows:
the current node first selects a corresponding relay node with a highest priority to forward the maritime search and rescue data packet, and if the relay node with the highest priority successfully receives the data packet, a reply packet is broadcast, and other relay nodes with lower priority discard the reply packet after receiving a successfully sent reply packet, and then the relay node with the highest priority is used as a new current node, and above steps are repeated;
if other relay nodes do not receive the reply packet, the current node selects a relay node with a second highest priority to forward the data packet, and so on, until other relay nodes receive the reply packet and discard the reply packet.

Further, after introducing the reliable response mechanism CACK (Credible, ACK), a number of ACK transmissions among the nodes is:

$$γ = [ 1 / {f}_{ACK} ] + 1$$

where f_{ACK} represents a delivery rate of the ACK;
a delivery rate of the reliable response mechanism CACK is:

$${P}_{CACK} = 1 - {( 1 - {f}_{ACK} )}^{γ}$$

where f_{ACK} represents the delivery rate of the ACK and y represents the number of ACK transmissions among nodes.

Compared with the prior art, the disclosure has following beneficial effects.

First, based on the temporal and spatial correlation of MSR-WSNs nodes, the disclosure designs an adaptive clustering mechanism of maritime search and rescue wireless sensor network nodes, and uses an adaptive filtering method to calculate the predicted values of advance distances of maritime search and rescue data packets, reducing the frequent exchange of location information among nodes and nodes within their communication range, thus improving the network scalability and saving the network energy consumption to a certain extent.

Second, based on the proposed adaptive clustering mechanism of search and rescue target nodes, the disclosure comprehensively considers the predicted values of advance distances of maritime search and rescue data packets, the connectivity of communication links in maritime search and rescue environment and the residual energy of nodes to calculate the priority of candidate relay nodes, thus ensuring the reliability and effectiveness of transmission paths and improving the forwarding rate of maritime search and rescue data packets.

Third, the disclosure introduces a reliable response mechanism CACK, which ensures that the success rate of routing response is close to 100%, thus greatly improving the efficiency and success rate of maritime search and rescue.

### BRIEF DESCRIPTION OF THE DRAWINGS

FIG. 1 is a flow chart of the present disclosure.

FIG. 2 is a typical scene diagram of maritime search and rescue using MSR-WSNs.

FIG. 3 is a comparative diagram of packet forwarding rates of four routing methods of high-reliability and high-robustness routing (HRHRR), dynamic source routing (DSR), Ad-hoc on-demand distance vector (AODV) and prediction based opportunistic routing protocol (POR) according to the present disclosure.

FIG. 4 is a comparison diagram of average end-to-end delays of four routing methods (HRHRR, DSR, AODV and POR protocol) according to the present disclosure.

FIG. 5 is a comparison diagram of normalized routing overheads of four routing methods (HRHRR, DSR, AODV and POR protocol) according to the present disclosure.

FIG. 6 is a comparison diagram of death numbers of nodes of four routing methods (HRHRR, DSR, AODV and POR protocol) according to the present disclosure.

### DETAILED DESCRIPTION OF THE EMBODIMENTS

The present disclosure is described in detail with the attached drawings and specific embodiments. This embodiment is implemented on the premise of the technical scheme of the present disclosure, and the detailed implementation and specific operation process are given, but the protection scope of the present disclosure is not limited to the following embodiments.

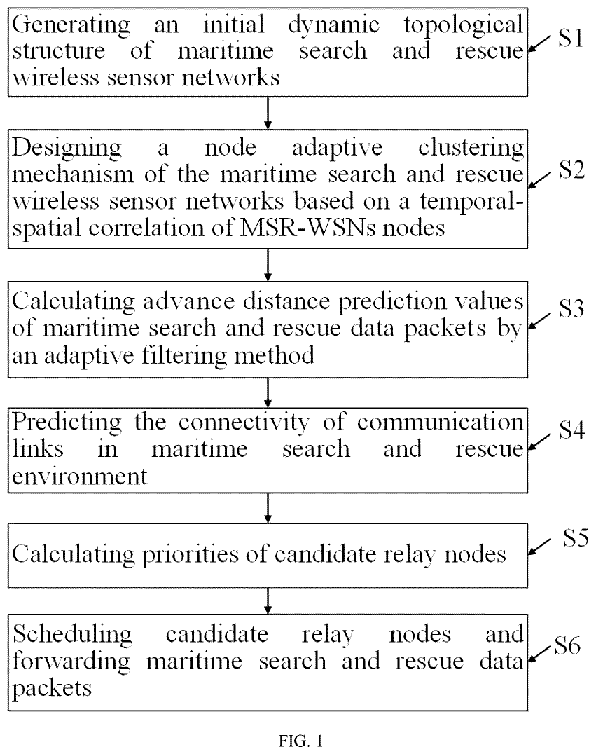

On the basis of comprehensively considering the complexity and particularity of the maritime search and rescue wireless sensor network, aiming at the requirements and characteristics of the routing design of maritime search and rescue wireless sensor networks (MSR-WSNs), the disclosure provides a high-reliability and high-robustness routing method for MSR-WSNs. On the basis of generating the initial dynamic topological structure of MSR-WSNs, in order to save network energy consumption and improve the scalability of the network, a node adaptive clustering mechanism of MSR-WSNs is designed based on the temporal and spatial correlation of MSR-WSNs nodes. Then, for each packet forwarding request, the prediction value of the advance distance of maritime search and rescue data packets is calculated by using adaptive filtering method, thus effectively solving the problem that collecting node position information in real time consumes a lot of energy. Then, under the sea wave shielding environment, a communication link connectivity prediction model in maritime search and rescue environment is proposed and the threshold of received signal strength is obtained by using Q function. Then, the priority of candidate relay nodes is calculated and scheduled. Finally, in the process of forwarding maritime search and rescue data packets, a reliable response mechanism, CACK, is introduced to ensure that the response success rate is close to 100%, thus greatly improving the efficiency and success rate of maritime search and rescue. The flow chart of the method is shown in FIG. 1. The disclosure solves the problem of robust and efficient transmission of perceptual data caused by frequent node movement, dynamic change of network topology, high delay and other characteristics in maritime search and rescue scenes. This method adapts to the wireless sensor network of maritime search and rescue with time-varying topology and unstable communication link, and realizes the high-reliability and high-robustness transmission of MSR-WSNs sensing data, effectively improves the efficiency and success rate of maritime search and rescue and reduces the network energy consumption.

The method includes following steps.

S1, generating an initial dynamic topological structure of MSR-WSNs, where the topological structure includes a plurality of maritime search and rescue nodes and target nodes, where the maritime search and rescue nodes are evenly distributed;

S2, generating a random number for any maritime search and rescue node and comparing the random number with a threshold value, and determining whether the maritime search and rescue node is a cluster head node according to a comparison result, where the maritime search and rescue node being not the cluster head node selects a maritime search and rescue cluster corresponding to a cluster head node with a smallest indication value of a maritime search and rescue cluster, and joins the maritime search and rescue cluster to obtain a set of maritime search and rescue clusters;

S3, calculating predicted values of advance distances of maritime search and rescue data packets of the target nodes by using an adaptive filtering method;

S4, predicting a connectivity of communication links in maritime search and rescue environment and calculating a correct reception rate among nodes;

S5, according to the set in the S2, determining a relay node of any maritime search and rescue node in each cluster, calculating a priority of each relay node according to the predicted values of the advance distances of the maritime search and rescue data packets in the S3, the correct reception rate between the nodes in the S4 and residual energy of the nodes, and ranking the priorities from high to low according to priority values; and
S6, taking any maritime search and rescue node receiving the maritime search and rescue data packet of the target node as a current node, introducing a reliable response mechanism, selecting a relay node corresponding to the current node to forward the data packet according to the priority, taking the relay node selected as a current node, and repeatedly selecting the relay node of the current node to forward until the maritime search and rescue data packet is successfully received by a search and rescue ship.

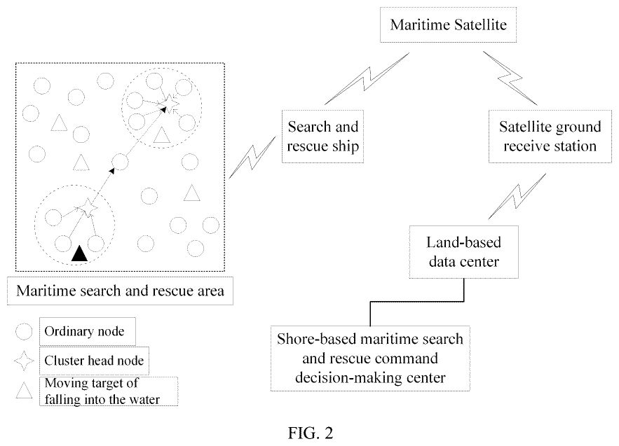

In the S1, the characteristics of maritime search and rescue environment and network characteristics of the MSR-WSNs are comprehensively analyzed, and the idea of dynamic clustering is introduced to classify various potential target nodes in maritime search and rescue according to their different functional requirements, communication capabilities and their own characteristics. Then, the initial dynamic topological structure of MSR-WSNs is generated by using a complex network theory. The typical scene diagram of maritime search and rescue using MSR-WSNs, meaning the dynamic topology structure, is shown in FIG. 2.

The specific steps of the S2 are as follows:

### (1) Cluster Head Election

randomly generating a random number between 0 and 1 for the maritime search and rescue node, and comparing the random number with the threshold value C(i). If the random number is less than the threshold value, the maritime search and rescue is selected as the cluster head. The expression of C(i) is:

$$C ( i ) = \{ \begin{matrix}max ( \frac{ℓ}{1 − ℓ ( r mod ( \frac{1}{ℓ} ) )} \times \frac{{e}_{residual}}{{e}_{initial}} , {C}_{min} ) , & ∀ i ϵ H \\ 0 , & else\end{matrix} \text{}$$

where e_{residual} represents residual energy of the node; eᵢₙᵢₜᵢₐₗ represents initial energy of the node; Cₘᵢₙ represents the minimum threshold value; H represents a set of MSR-WSNs nodes that have not been selected as cluster heads in the previous 1/ [symbol] round.

### (2) Formation of Cluster Members

First, following three definitions are given:
Definition 1: received signal strength value similarity (RS). Assuming that RSSI; and RSSIⱼ are the received signal strength values of maritime search and rescue nodes nᵢ and nⱼ respectively, and RS between the maritime search and rescue nodes nᵢ and nⱼ may be defined as follows:

$$RS ( {n}_{i} , {n}_{j} ) = \vert \frac{{RSSI}_{i} - {RSSI}_{j}}{{RSSI}_{i}} \vert \times 100 \%$$

Definition 2: geographic location information similarity (GLS). Assuming that lᵢ and lⱼ are locations of the maritime search and rescue nodes nᵢ and nⱼ respectively, and GLS between the maritime search and rescue nodes nᵢ and nⱼ may be defined as follows:

$$G L S ( {n}_{i} , {n}_{j} ) = \vert {l}_{i} - {l}_{j} \vert$$

Definition 3: adding the corresponding maritime search and rescue cluster instruction (MSR_{Instruction}). RS(nᵢ, nⱼ) and GLS (nᵢ, nⱼ) are further regularized between 0 and 1, and naming NRS(nᵢ, nⱼ) and NGLS(nᵢ, nᵢ) respectively. The smaller the value RS and the value GLS, the stronger the temporal-spatial correlation between the two nodes. MSR_{Instruction} is defined as:

$${MSR}_{Instruction} ( {n}_{i} , {n}_{j} ) = {ω}_{1} \times NRS ( {n}_{i} , {n}_{j} ) + {ω}_{2} \times NGLS ( {n}_{i} , {n}_{j} )$$

where ω₁ and ω₂ represent the weight coefficients of RS and GLS respectively, and satisfy: ω₁+ω₂=1(ω₁≥ω₂). The value of MSR_{Instruction} is used as a measure that ordinary nodes join the corresponding maritime search and rescue cluster. Ordinary nodes choose the cluster head node corresponding to the minimum value of MSR_{Instruction} and join the cluster. Finally, a set of maritime search and rescue clusters is output, and the nodes in each cluster have strong temporal and spatial correlation, this is helpful to realize the efficient and reliable transmission of maritime search and rescue data packets by using MSR-WSNs with limited energy and bandwidth.

The specific steps of S3 are as follows:
dᵢ_{ⱼ} represents the advance distance towards the search and rescue ship (MSR-Ship) when the maritime search and rescue data packet sent by the node i is forwarded by the neighbor node iⱼ:

$${d}_{{i}_{j}} = d ( i , MSR - Ship ) - d ( {i}_{j} , MSR - Ship )$$

where d(i,MSR-Ship) represent Euclidean distances between i and MSR-Ship and d(iⱼ,MSR-Ship) represent Euclidean distances between i; and MSR-Ship.

An MSR packet is used to periodically exchange position information between neighboring nodes and keep latest advance values of q historical data packet for each neighboring node. For each packet forwarding request, Adaptive Filtering Method (AFM) is used to calculate the predicted values of the advance distances of data packets. Defining the advance values of the q historical data packets of the neighbor node i, as follows: \hat{d}ᵢ_{ⱼ}^{t-1}, \hat{d}ᵢ_{ⱼ}^{t-2}, . . . , \hat{d}ᵢ_{ⱼ}^{t-q}. Then the packet advance prediction value at the timing t is as follows:

$${{d}^{⌢}}_{{i}_{j}}^{t} = {ω}_{1}^{′} {{d}^{⌢}}_{{i}_{j}}^{t - 1} + {ω}_{2}^{′} {{d}^{⌢}}_{{i}_{j}}^{t - 2} + … + {ω}_{q}^{′} {{d}^{⌢}}_{{i}_{j}}^{t - q}$$

where the updating formula of weight coefficient is ωᵢ^{t}′=ωᵢ^{t-1}′+2veᵢ\hat{d}ᵢ_{ⱼ}^{t-i} (v for a learning constant, eᵢ for a prediction error of \hat{d}ᵢ_{ⱼ}^{t}).

The specific steps of the S4 are as follows:

In the maritime search and rescue environment, with the ups and downs of waves, the quality of communication links among nodes is randomly affected by the shielding effect of waves. According to the theoretical path loss model, the signal strength P_{R}(d) of information sent by a node with a distance of d received by the node i is:

$${[ {P}_{R} ( d ) ]}_{dBm} = {[ {P}_{T} ]}_{dBm} - {[ PL ( {d}_{0} ) ]}_{dBm} - 10 α {log}_{10} ( \frac{d}{{d}_{0}} ) - {[ {X}_{σ} ]}_{dBm}$$

P_{T} represents a transmitting power of the node, PL(d₀) represents a signal strength loss value when the reference distance d₀=1 m, α represents a path loss attenuation index, and X_{σ} represents a wave shielding factor obeying the Gaussian distribution with an expected value of 0 and a variance of σ².

When the transmitting power is constant, the signal strength P_{R}(d) received by the node is a random variable. When the signal strength value received by the node is greater than the threshold Th, the stability of connectivity among nodes may be guaranteed. In the wave shielding environment, to ensure the successful communication among nodes at a distance of d, the transmitting power P_{T} of the node satisfies following conditions:

$${P}_{T} \geq PL ( {d}_{0} ) + 10 α {log}_{10} ( \frac{d}{{d}_{0}} ) + Th + {X}_{σ} ;$$

the threshold Th is calculated using the Q function. [symbol] is taken as the correct reception rate when the distance is d, and the expression is as follows:

$$P ( {P}_{R} ( d ) \geq Th ) = = Q ( \frac{Th - {E}_{{P}_{R} ( d )}}{σ} )$$

$$where$$

$$Q ( Z ) = \frac{1}{\sqrt{2 π}} ( {\int }_{Z}^{∞} exp ( \frac{- {χ}^{2}}{2} ) dx )$$

The specific steps of the S5 are as follows:

The candidate relay nodes of the node i at the current timing t are all nodes in the intersection set of the node set in the cluster and the neighbor node set within the communication range. Based on the adaptive movement model of search and rescue target nodes, the priority of candidate relay nodes is calculated by comprehensively considering the predicted values of the advance distances of maritime search and rescue data packets, the connectivity of communication links in maritime search and rescue environment and the residual energy of nodes, and the formula for calculating the priority of the candidate relay node j at the timing t is defined as:

$${P}_{{i}_{j}} ( t ) = ln ( 1 + {\hat{d}}_{{i}_{j}}^{t} \cdot \cdot {e}_{{i}_{j} - residual}^{t} )$$

where eᵢ_{ⱼ}_{-residual}^{t} represents the residual energy of the node at the timing t. Then, the priorities of all candidate relay nodes are sorted from high to low according to the node priority Pᵢ_{ⱼ}(t).

The specific steps of the S6 are as follows:

After determining the priority of the candidate relay node, the maritime search and rescue data packet are forwarded from the node with the highest priority. After the forwarding is successful, a reply packet is broadcast, the forwarding node with lower priority discards the packet after receiving the successfully sent reply packet. If the reply packet is not received, the node with the second priority is started to forward the maritime search and rescue data packets, and this process continues until the maritime search and rescue data packet is successfully received. In practice, it is possible that the maritime search and rescue data packet is successfully transmitted, but the reply packet is lost, thus leading to unnecessary repeated transmission of data packets and waste of bandwidth and energy of MSR-WSNs. In order to solve this problem, the disclosure introduces a reliable response mechanism, CACK (Credible, ACK). It is known that the delivery rate of ACK between two nodes is f_{ACK}, and the sending number of ACK is specified as

$$γ = [ \frac{1}{{f}_{ACK}} ] + 1 ;$$

therefore, the delivery rate of CACK is:

$${P}_{CACK} = 1 - {( 1 - {f}_{ACK} )}^{γ}$$

In this way, the success rate of response may be guaranteed to be close to 100%, thus greatly improving the efficiency and success rate of maritime search and rescue.

The following simulation experiments are conducted:
the required network simulation environment is simulated through the network simulation tool NS2 under Linux system, the high-reliability and high-robustness routing (HRHRR) method for sensing data in MSR-WSNs is simulated and analyzed, so as to further introduce the implementation of the example of the disclosure and its advantages in the field of maritime search and rescue. Three routing protocols-dynamic source routing: Dynamic Source Routing (DSR), Ad-hoc On-demand Distance Vector (AODV) and Prediction based Opportunistic Routing protocol (POR) are selected as benchmark algorithms to compare and analyze with the proposed routing method HRHRR for maritime search and rescue wireless sensor networks. are selected as benchmark algorithms to compare and analyze with the proposed routing method HRHRR for MSR-WSNs. Other simulation parameters are shown in Table 1 below:

TABLE 1
Simulation Parameter Table

| Parameters | Values | |
|---|---|---|
| Scope of maritime search and rescue simulation | 800 m × 800 m | |
| scene | | |
| Number of nodes | 200 | |
| Node initial energy | 3 | J |
| Maximum communication radius of nodes | 260 | m |
| Maximum moving speed of nodes | 6 | m |
| Channel bandwidth | 2 | Mbps |
| Flow model | CBR (Constant Bit | |
| | Rate) | |
| Radio wave transmission mode | Two Ray Ground | |
| Data packet size | 512 | bytes |
| Broadcast packet size | 30 | bytes |
| Node transmission and reception energy | 50 | nJ/bit |
| consumption | | |
| Multiple Access Control (MAC) protocol | IEEE 802.11 | |
| Simulation time | 1200 | s |

After the system runs the simulation, the trace data file is analyzed and extracted by GAWK, and then the simulation data is obtained after sorting, which is drawn by Matlab R2016b, as shown below.

Four routing protocols are compared from following four aspects:
1) Packet forwarding rate;
2) Average end-to-end delay;
3) Normalized routing overhead;
4) Number of deaths of maritime search and rescue nodes.

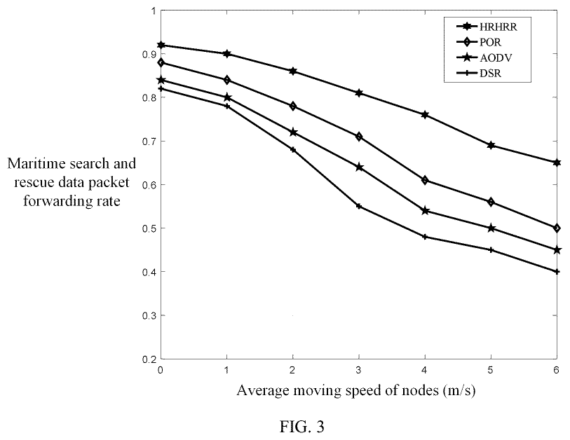

FIG. 3 is a comparison diagram of the packet forwarding rate performance between the highly reliable and robust routing method proposed by the present disclosure and the existing routing method with the increase of the average moving speed of nodes. As can be seen from FIG. 3, compared with DSR, AODV and POR protocols, the proposed routing method improves the packet forwarding rate by 14.56%, 24.51% and 34.38% respectively. The main reason is that the proposed HRHRR method accurately predicts the connectivity of communication links on the basis of adaptive clustering of MSR-WSNs nodes, and updates the link connectivity probability value in real time, which ensures the reliability of the transmission path of maritime search and rescue data packets, thus reducing the packet loss rate. However, DSR, AODV and POR protocols do not consider the reliability of links, which leads to routing holes and path interruptions. At the same time, HRHRR method uses opportunistic routing technology to form multiple communication links, and introduces a reliable response mechanism CACK to ensure that the response success rate is close to 100%, which effectively improves the forwarding rate of maritime search and rescue data packets.

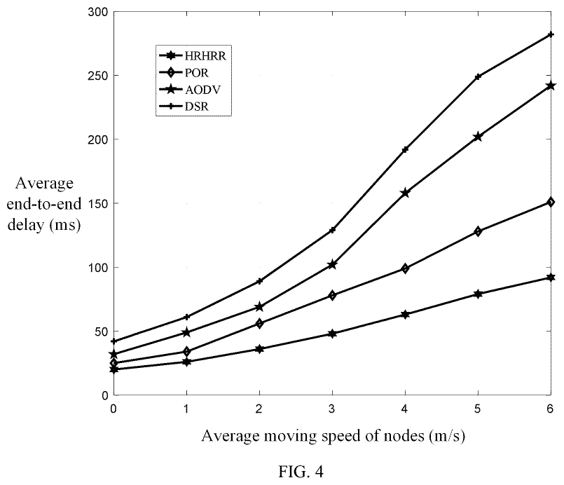

FIG. 4 is a comparison diagram of the average end-to-end delay performance between the high-reliability and high-robustness routing method proposed by the present disclosure and the existing routing method with the increase of the average moving speed of nodes. As can be seen from FIG. 4, compared with DSR, AODV and POR protocols, the proposed HRHRR method reduces the average end-to-end delay index by 36.25%, 57.38% and 65.13% respectively. Because HRHRR method considers the connectivity of communication links and combines with adaptive filtering method to calculate the predicted values of the advance distances of maritime search and rescue data packets, the end-to-end delay is effectively reduced. At the same time, the path with higher reliability may always give priority to the transmission of maritime search and rescue data packets, which avoids the retransmission of data and reduces the end-to-end delay to some extent.

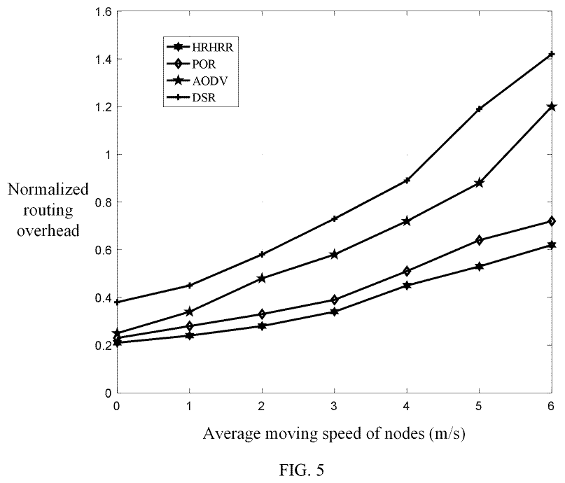

FIG. 5 is a comparison diagram of the normalized routing overhead performance between the high-reliability and high-robustness method proposed by the present disclosure and the existing routing method with the increase of the average moving speed of nodes. As can be seen from FIG. 5, compared with DSR, AODV and POR protocols, the proposed HRHRR method reduces the normalized routing overhead by 13.89%, 40.00% and 52.66% respectively. The main reason is that the routing method of the disclosure uses the space-time relationship of MSR-WSNs network topology and combines with the adaptive filtering method to calculate the predicted values of the advance distances of maritime search and rescue data packets, which effectively reduces the frequent exchange of location information among nodes and nodes within their communication range. At the same time, the routing request packet forwarding selects the path with the best communication quality instead of blindly flooding through all the accessible paths, thus avoiding the blind broadcast of the request message, thus reducing a large number of invalid routing request packets, thus reducing the routing overhead in the network to a great extent.

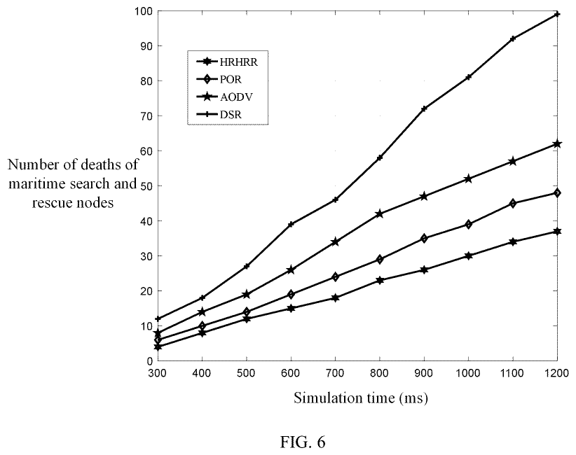

FIG. 6 is a comparison diagram of the performance of the number of deaths of maritime search and rescue nodes between the high-reliability and high-robustness routing method proposed by the present disclosure and the existing routing method along with the simulation. As can be seen from FIG. 6, compared with DSR, AODV and POR protocols, the number of dead nodes in the proposed HRHRR method is the least in different time periods. The main reason is that when selecting the routing path, HRHRR method considers the residual energy of nodes on the path, and the path with more residual energy is more likely to be used to transmit maritime search and rescue data packets, which balances the network load to some extent and avoids the premature death of nodes due to excessive load, thus reducing the number of dead nodes of MSR-WSNs and prolonging the network life compared with other routing methods.

The preferred embodiments of the present disclosure have been described in detail above. It should be understood that those skilled in the art may make many modifications and changes according to the concept of the present disclosure without creative work. Therefore, any technical scheme that may be obtained by a person skilled in the technical field through logical analysis, reasoning or limited experiments on the basis of the existing technology according to the concept of the present disclosure should be within the protection scope determined by the claims.

What is claimed is:

1. A high-reliability and high-robustness routing method for MSR-WSNs, comprising following steps:
S1, generating an initial dynamic topological structure of MSR-WSNs, wherein the topological structure comprises a plurality of maritime search and rescue nodes and target nodes, wherein the maritime search and rescue nodes are evenly distributed;
S2, generating a random number for any maritime search and rescue node and comparing the random number with a threshold value, and determining whether the maritime search and rescue node is a cluster head node according to a comparison result, wherein the maritime search and rescue node being not the cluster head node selects a maritime search and rescue cluster corresponding to a cluster head node with a smallest indication value of a maritime search and rescue cluster, and joins the maritime search and rescue cluster to obtain a set of maritime search and rescue clusters;
S3, calculating predicted values of advance distances of maritime search and rescue data packets of the target nodes by using an adaptive filtering method;
S4, predicting a connectivity of communication links in maritime search and rescue environment and calculating a correct reception rate among nodes;
S5, according to the set in the S2, determining a relay node of any maritime search and rescue node in each cluster, calculating a priority of each relay node according to the predicted values of the advance distances of the maritime search and rescue data packets in the S3, the correct reception rate between the nodes in the S4 and residual energy of the nodes, and ranking the priorities from high to low according to priority values; and
S6, taking any maritime search and rescue node receiving the maritime search and rescue data packet of the target node as a current node, introducing a reliable response mechanism, selecting a relay node corresponding to the current node to forward the data packet according to the priority, taking the relay node selected as a current node, and repeatedly selecting the relay node of the current node to forward until the maritime search and rescue data packet is successfully received by a search and rescue ship.

2. The high-reliability and high-robustness routing method for MSR-WSNs according to claim 1, wherein an indication value of the maritime search and rescue cluster is:
$${MSR}_{Instruction} ( {n}_{i} , {n}_{j} ) = {ω}_{1} \times NRS ( {n}_{i} , {n}_{j} ) + {ω}_{2} \times NGLS ( {n}_{i} , {n}_{j} )$$
wherein nᵢ and nⱼ represent i-th and j-th maritime search and rescue nodes respectively, ω₁ and ω₂ represent weight coefficients of a received signal strength value similarity and a geographical location information similarity respectively, NRS represents a regularized received signal strength value similarity, and NGLS represents a regularized geographical location information similarity.

3. The high-reliability and high-robustness routing method for MSR-WSNs according to claim 1, wherein the predicted values of the advance distances of the maritime search and rescue data packets are:
$${\hat{d}}_{{i}_{j}}^{t} = {ω}_{1}^{′} {\hat{d}}_{{i}_{j}}^{t - 1} + {ω}_{2}^{′} {\hat{d}}_{{i}_{j}}^{t - 2} + … + {ω}_{q}^{′} {\hat{d}}_{{i}_{j}}^{t - q}$$
wherein \hat{d}ᵢ_{ⱼ}^{t-1}, \hat{d}ᵢ_{ⱼ}^{t-2}, . . . \hat{d}ᵢ_{ⱼ}^{t-q} represent predicted values of advance distances of q maritime search and rescue data packets towards the search and rescue ship when the maritime search and rescue data packets sent to the node i are forwarded by a neighbor node i, of the node i, \hat{d}ᵢ_{ⱼ}^{t} represents a predicted value of the advance distance of the maritime search and rescue data packets at a timing t, wherein ω′ represents weight, and an update of ω′ is:
$${ω}_{i}^{′ t} = {ω}_{i}^{′ t - 1} + 2 υ {e}_{i} {\hat{d}}_{{i}_{j}}^{t - i}$$
wherein v represents a learning constant, and eᵢ represents a learning error of \hat{d}ᵢ_{ⱼ}^{t}.

4. The high-reliability and high-robustness routing method for MSR-WSNs according to claim 3, wherein the advance distance represents a difference between a Euclidean distance between node i and the search and rescue ship and a Euclidean distance between node i; and the search and rescue ship.

5. The high-reliability and high-robustness routing method for MSR-WSNs according to claim 1, wherein the correct reception rate between the nodes is:
$$P ( {P}_{R} ( d ) \geq Th ) = = Q ( \frac{Th - {E}_{{P}_{R} ( d )}}{σ} )$$
wherein [symbol] represents a correct reception rate, P_{R}(d) represents a signal strength received by the nodes, d represents a distance between the node sending information and the node receiving information, Th represents an information strength threshold; if the signal strength received by nodes is greater than or equal to the information strength threshold, a correct reception among nodes is realized,
wherein
$$Q ( Z ) = \frac{1}{\sqrt{2 π}} {\int }_{Z}^{∞} exp ( \frac{- {χ}^{2}}{2} ) dx$$
the signal strength of the node i receiving information sent by a node with a distance d is:
$${[ {P}_{R} ( d ) ]}_{dBm} = {[ {P}_{T} ]}_{dBm} - {[ PL ( {d}_{0} ) ]}_{dBm} - 10 α {log}_{10} ( \frac{d}{{d}_{0}} ) - {[ {X}_{σ} ]}_{dBm}$$
wherein P_{T} represents transmitting power of the nodes, PL(d₀) represents a signal strength loss value when a reference distance d₀=1 m, α represents a path loss attenuation index, and X_{σ} represents a wave shielding factor obeying Gaussian distribution with an expected value of 0 and a variance of σ².

6. The high-reliability and high-robustness routing method for MSR-WSNs according to claim 5, wherein when the correct reception is realized among the nodes, the transmitting power of the nodes satisfies:
$${P}_{T} \geq PL ( {d}_{0} ) + 10 α {log}_{10} ( \frac{d}{{d}_{0}} ) + Th + {X}_{σ}$$
wherein PL(d₀) represents the signal strength loss value when the reference distance d₀=1 m, αrepresents the path loss attenuation index, and X, represents the wave shielding factor obeying the Gaussian distribution with the expected value of 0 and the variance of σ².

7. The high-reliability and high-robustness routing method for MSR-WSNs according to claim 1, wherein specific steps of determining the relay node of the node i are as follows:
for the node i, calculating an intersection unit of a node set in a cluster where the node i is located and a neighbor node set of the node i, and taking all nodes in the intersection set as relay nodes of the node i.

8. The high-reliability and high-robustness routing method for MSR-WSNs according to claim 1, wherein the priority of the relay nodes of the node i is:
$${P}_{{i}_{j}} ( t ) = ln ( 1 + {\hat{d}}_{{i}_{j}}^{t} \cdot \cdot {e}_{{i}_{j} - residual}^{t} )$$
wherein \hat{d}ᵢ_{ⱼ}^{t} represents a predicted value of the advance distance of the maritime search and rescue data packet at a timing t, [symbol] represents the correct reception rate, and eᵢ_{ⱼ}_{-residual}^{t} represents the residual energy of the node at the timing t.

9. The high-reliability and high-robustness routing method for MSR-WSNs according to claim 8, wherein specific steps of selecting the relay node corresponding to the current node for data packet forwarding according to the priority are as follows:
the current node first selects a corresponding relay node with a highest priority to forward the maritime search and rescue data packet, and if the relay node with the highest priority successfully receives the data packet, a reply packet is broadcast, and other relay nodes with lower priority discard the reply packet after receiving a successfully sent reply packet, and then the relay node with the highest priority is used as a new current node, and above steps are repeated;
if other relay nodes do not receive the reply packet, the current node selects the relay node with a second highest priority to forward the data packet, and so on until other relay nodes receive the reply packet and discard the reply packet.

10. The high-reliability and high-robustness routing method for MSR-WSNs according to claim 9, wherein after introducing the reliable response mechanism CACK (Credible, ACK), a number of ACK transmissions among the nodes is:
$$γ = [ 1 / {f}_{ACK} ] + 1$$
wherein f_{ACK} represents a delivery rate of the ACK;
a delivery rate of the reliable response mechanism CACK is:
$${P}_{CACK} = 1 - {( 1 - {f}_{ACK} )}^{γ}$$
wherein f_{ACK} represents the delivery rate of the ACK and y represents the number of ACK transmissions among nodes.
